(19) United States
(12) Patent Application Publication
(10) Pub. No.: US 2008/0010376 A1
(43) Pub. Date: Jan. 10, 2008

(54) SYSTEM AND METHOD FOR PERSONALIZED ONLINE EDUCATION

(76) Inventors: Jesse Nahan, Cambridge, MA (US); Marion Rogers, Cambridge, MA (US)

Correspondence Address: MANELLI DENISON & SELTER, 2000 M STREET NW SUITE 700, WASHINGTON, DC, 20036-3307, US

(21) Appl. No.: 11/773,484

(22) Filed: Jul. 5, 2007

Related U.S. Application Data
(60) Provisional application No. 60/818,798, filed on Jul. 6, 2006.

(51) Int. Cl. G06F 15/173

(52) U.S. Cl. 709/225; 434/350

(57) ABSTRACT

This invention relates to a system and method for providing personalized online education.

This application claims priority to U.S. provisional patent appl'n Ser. No. 60/818,798, filed on 6 Jul. 2006, the complete disclosure of which is incorporated herein by reference.

### FIELD OF THE INVENTION

This invention relates to a system and method for providing personalized online education.

### BACKGROUND OF THE INVENTION

Online education is a broad term that generally refers to facilitating learning over the Internet. Online education is accessed through desktop and laptop computers as well as handheld devices such as personal digital assistants (PDAs) and Web-enabled cellphones. There is a trend in developing online-capable devices that place an increasing number of features and computing power in increasingly smaller packages. Some of these future devices may also be capable of delivering online education.

Online education can have problems engaging students, can be impersonal and can be difficult to navigate. Just as with standard education, students using online education can forget important material and skills if they don't receive regular reinforcement after taking a course.

Conventional online education systems have means for retaining a profile of the student. For example, U.S. Pat. No. 6,386,883 discloses an online education system in which a student profile is retained regarding the student's capabilities. However, this patent does not address the problems of navigation and reinforcement. Nor does this patent address the issue of personalizing the educational experience.

### SUMMARY OF THE INVENTION

An objective is to provide a system and method for online education that makes it easy for students to personalize their instruction and navigate their instruction in multiple ways.

Another objective is to transform online education from a take-it-once course into a personalized support system that is available to students the entire time they are in school or college or to employees the entire time they are at a company. One of the results of this system and method is an increase in student engagement. Students who are engaged in their learning are more likely to remain in school, graduate college or otherwise complete their educational program.

Further objects include the following:

Provide access to the instructional materials throughout a student's attendance at a school, college or training institution, or during the entire time that an employee remains at a company.

Provide a multi-featured personalized area within the instructional program to help students make the material more meaningful to them.

Provide a quick and simple system to attach personalized notes to instructional materials while remaining in place within the program. The system automatically organizes those notes through multiple methods including key words, tags and instructional context. The system provides one-click access from each note back to specific original material. The system also relates the notes to the potential application of the instructional material where applicable. These notes become part of the student's personalized library of instruction.

Provide access to the personalized components through multiple methods, including a browser on a desktop or laptop computer and handheld devices, Web-enabled cellphones and other portable devices with online access.

Provide the user with a “jump back to where I was” feature to provide continuity between sessions or to ease the problem of equipment or communication malfunction when using the program.

Provide the user with multiple navigation methods. This allows users to pick and choose the material they want to review as well as multiple methods of finding the information/instructional material they seek.

Provide the user with one-click access to contextual information. At any point, users are able to view where they are in the instructional program and gain more insight by that contextual information.

Provide short and long term goal, task lists and learning reflections with links to instructional material.

Our system and method can be used in conjunction with conventional online education programs and improves them by providing the following:

Allowing the user to access the material throughout their attendance at a school, college or training institution that is using the system, or through the length of their employment at a company that is using the system.

Allowing the user to build a personalized library of instruction attached to their own notes, with one-click access to specific instructional material from personalized notes.

Providing the user a system to store and organize tasks and goals related to the instructional material.

Providing the user the ability to store their learning reflections as they progress through the instructional material.

Users have the option of sharing their learning reflections on an entry by entry basis. The sharing will be through Internet posting formats, such as blogging.

Allowing the user to return to the exact last place they worked on when starting a new session or after an equipment or communication malfunction.

Providing additional access to the personalized areas of instructional notes, tasks, goals and learning reflections through handheld, Web-enabled cellphone and other portable devices.

Showing the user the context of their instruction, at any point, with a single click.

Providing the user with multiple navigational methods to quickly locate material.

The end-users can include, for example, students at schools, colleges and training institutes, full-time, part-time or freelance staff at companies undergoing training, or anyone using online education.

### BRIEF DESCRIPTION OF THE DRAWINGS

FIG. 1 is the login screen to the program;

FIG. 2 is the home page of the program, which is the first page of the program the user sees after successfully logging in;

FIG. 3 is a sample instructional page that displays the global function buttons accessible throughout the program;

FIG. 4 displays the floating Add To My Journal palette;

FIG. 5 is a sample of instructional context, which provides the user with a visual representation of where they are within the program and can navigate to other sections;

FIG. 6 displays accessing the user's personalized area through the global buttons;

FIG. 7 is all of the main elements of the journal;

FIG. 8 displays the Jump To The Last Section feature;

FIG. 9 is the handheld device view of the user's personalized library of instruction;

FIG. 10 is the handheld device view of the user's personalized task lists;

FIG. 11 is the handheld device view of the user's short and long-term goals; and

FIG. 12 is the handheld device view of the user's learning reflections.

### DETAILED DESCRIPTION OF THE INVENTION

The system and method of providing personalized online education will now be explained with reference to attached Figs. without being limited thereto.

The system and method providing personalized online education comprises a personalized education program that can be run on now well-known computer systems and communication means that are used for online education. Examples of U.S. patents describing conventional online education systems that can be improved upon by incorporation of the personalized education program include 6,622,003, 6,674,992 and 6,988,138, the disclosures of which are incorporated herein by reference. The personalized education program can easily be programmed into any online education system based on the general programming knowledge of one of ordinary skill in the art. The user connects to the computer system running the personalized education program according to the invention described herein using any desired communication means, for example, desktop computers, laptop computers, and handheld devices such as pda's and web-enabled cellphones. Thus, the system comprises any desired computer system for running online education in combination with the personalized education program. The method comprises the steps provided in the personalized education program described below.

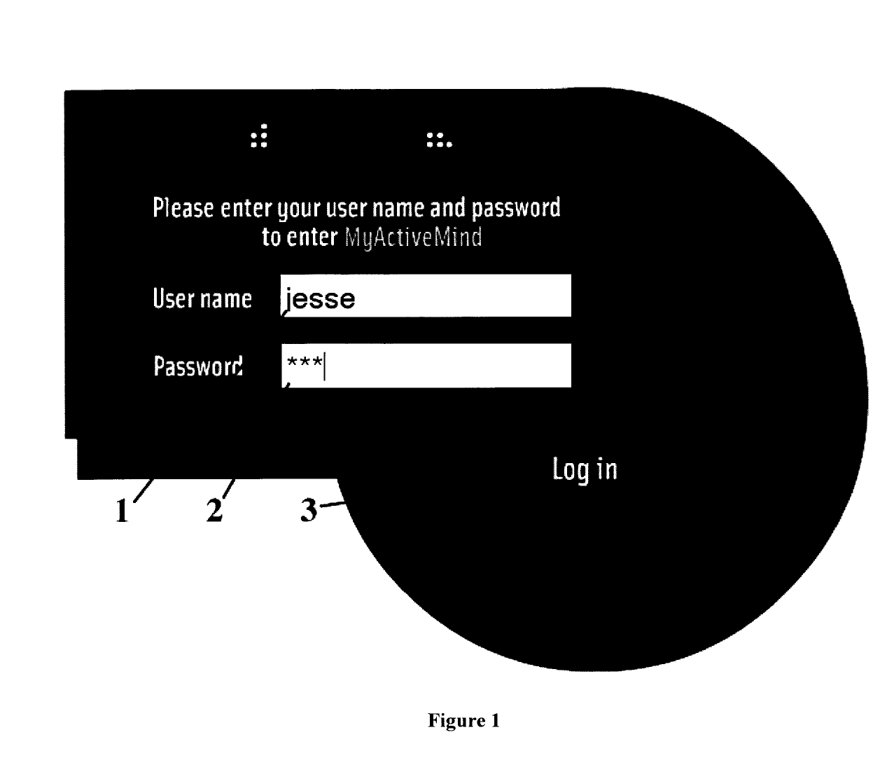

FIG. 1 shows the login screen to the personalized education program (hereinafter “program”) a user sees when they connect with the computer system running the program. The user types in their Username 1 and Password 2. The user then presses Login button 3 to send the information to the database. If the login information is correct, the user is allowed to proceed. If not, the user is directed to enter Username 1 and Password 2 again.

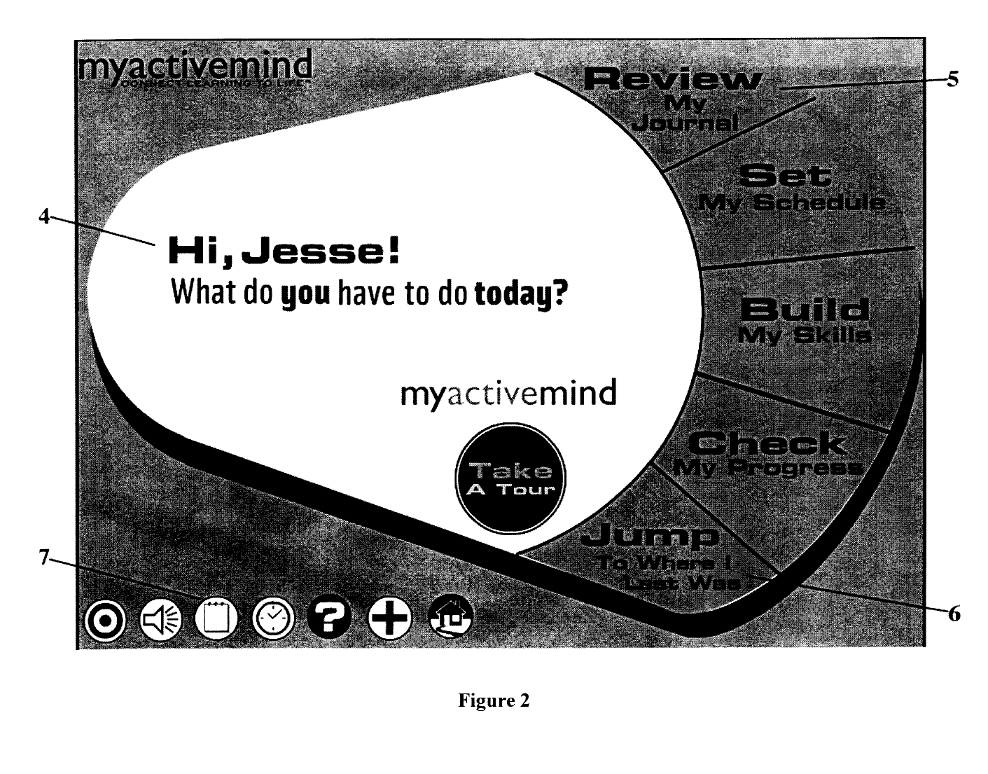

FIG. 2 shows the home page of the program. This is the first page the user sees after successfully logging in. The user is acknowledged personally by the Greeting 4. The user is presented with the overall options for the program on this page, including the Review My Journal button 5, the global Review My Journal button 7 and the Jump To Where I Was button 6.

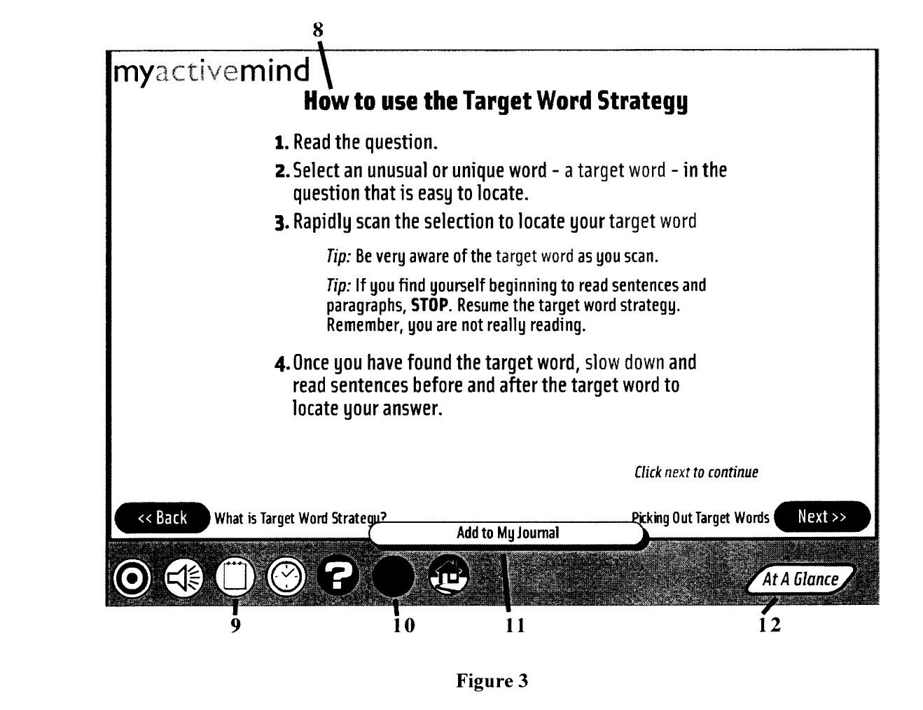

FIG. 3 shows a sample instructional page within the program including the title of the instruction 8 as follows:

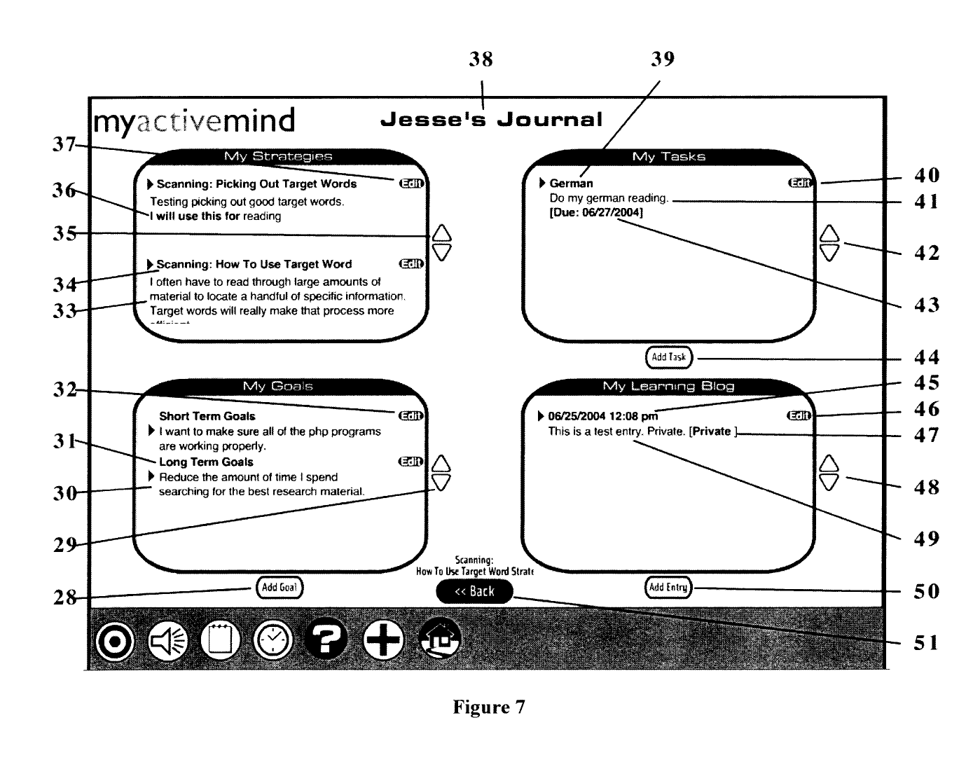

The user can press the global My Journal button 9 to access the personalized components of the Journal. If the user presses this button, they will be able to return to this exact page by pressing the Back button (FIG. 7, #51) on the Journal page.

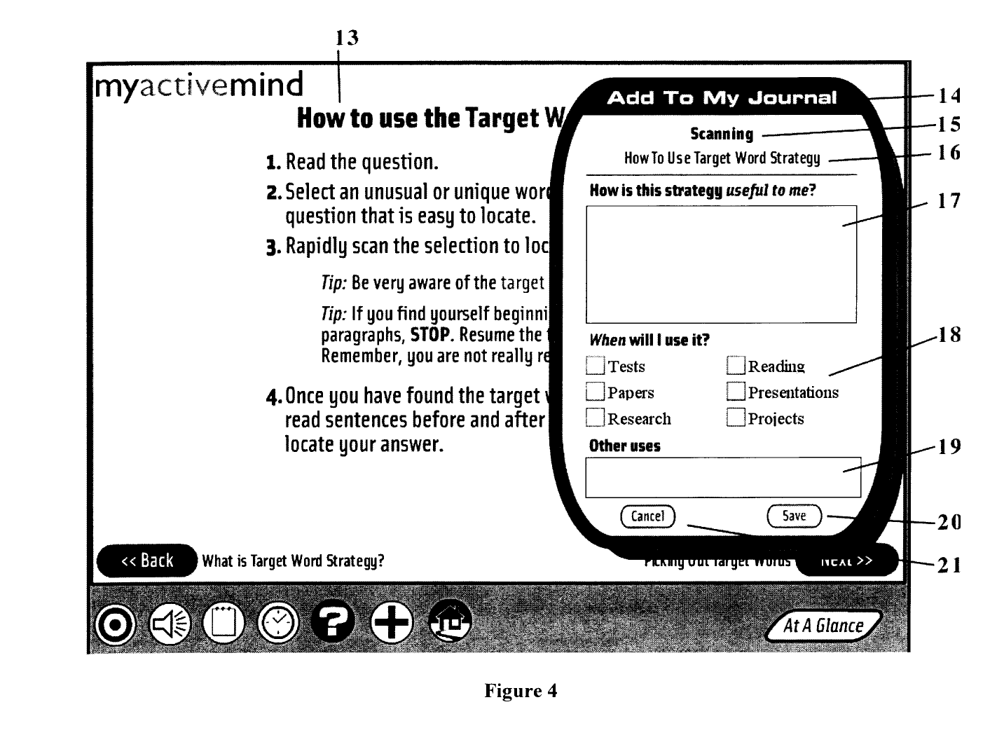

The user can press the global Add To My Journal button 10 to add this page to their personalized strategies. Pressing this button 10 displays the floating Add To My Journal palette (FIG. 4).

When the mouse pointer is placed over the global buttons, a tool tip for that button appears such as the Add To My Journal tool tip 11.

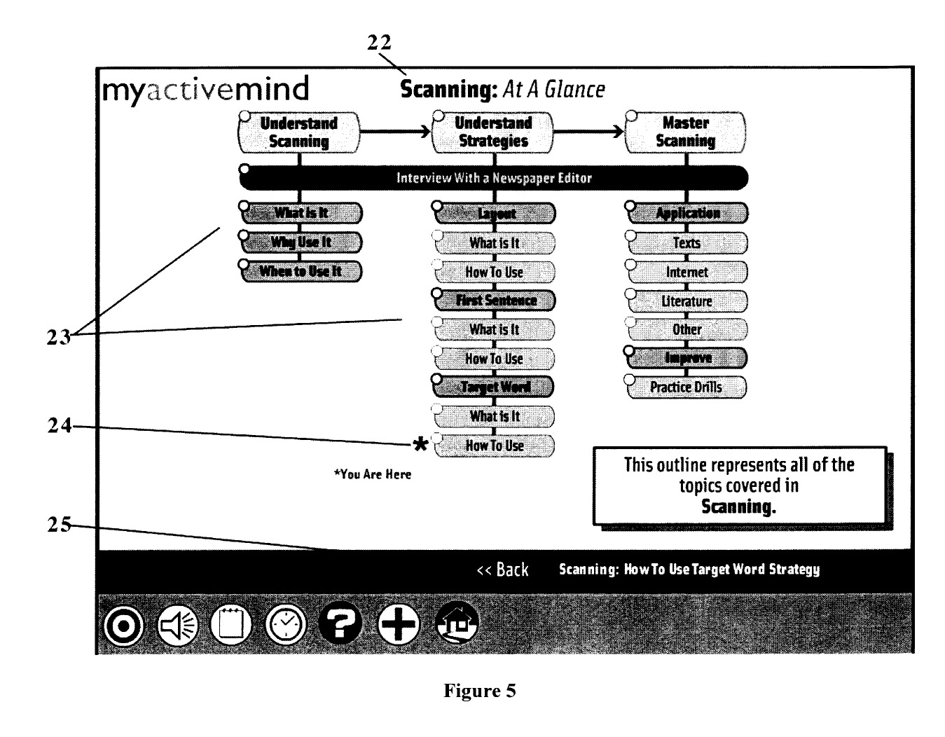

The user can press the global At A Glance button 12 to see where they are in the context of the instruction (FIG. 5).

FIG. 4 shows the palette Add To My Journal floating above the page of instruction with title 13. The Palette Title 14 explains its general purpose of adding the page to the user's journal. The current Subject 15 and current Page Headline 16 are displayed on the palette for saving. The user may enter a Personalized Note 17. Checkboxes 18 are for quickly noting the situations the instruction may be useful. The user may enter Other Uses 19 to expand upon the Checkboxes 18. The user may then press the Save button 20 to send the information to the database for storage or press the Cancel button 21 to cancel the entry. After either the Save button 20 or Cancel button 21 are pressed, the palette is removed from the screen, leaving the user at the same point in the program they were before opening the palette.

FIG. 5 shows the instructional context and the user's current position within the overall instruction. The subject of the Main Instruction 22 appears at the top of the screen. The components of the instruction are represented by the Modules 23. Pressing on one of the Modules 23 will take the user to that instructional component. The user is presented with a visual indication of their place within the program with the “You are here” star and text 24. The user may press the Back button 25 to return to the exact place where they first pressed the At A Glance global button (FIG. 3, #12).

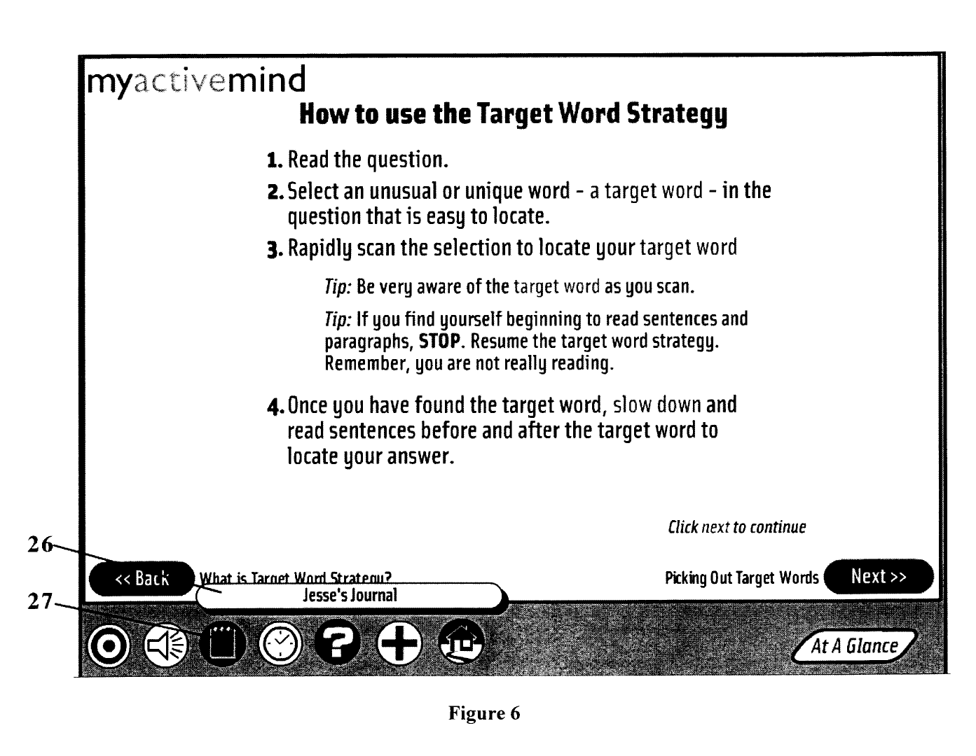

FIG. 6 shows a descriptive Tool tip 26 that appears over the My Journal button 27 when the user's mouse pointer is placed over the button. The My Journal button 27 is one of the global buttons, available at all points in the program. Pressing the My Journal button 27 displays the user's My Journal Page (FIG. 7), which provides access to their personalized instructional notes (“My Strategies”), tasks, goals and learning reflections.

FIG. 7 shows the My Journal page with each of the main components under the personalized page header 38, as follows:

My Goals displays a scrollable list of Goals 30 that are displayed under the Goal categories 31 (short- or long-term goals). Each Goal 30 can be edited by pressing the Edit Goal button 32 associated with it. The Scroll buttons 29 are used to scroll through the list of Goals 30. Pressing the Add Goal button 28 allows the user to add a new goal.

My Strategies displays a scrollable list of specific pages from the instructional program that are identified by the Page Reference 34. The Page Reference 34 is also an active link that, when pressed, will take the user to the original instructional page for review. The Personalized Note 33 the user previously entered about the instruction appears below the Page Reference 34. The Situations When The Instruction May Be Helpful 36 appear after the Personalized Note 33. Each Page Reference 34 is linked to an Edit Strategy button 37. The user can press the Scroll buttons 35 to scroll through the strategies.

My Tasks displays a scrollable list of tasks entered by the user. Each task has a Description 41 and a Class or Activity 39 associated with the task. Each task has a Due Date 16 and is linked to an Edit Task button 40. The user can press the Scroll buttons 42 to scroll through the tasks. New tasks can be added by pressing the Add Task button 44.

My Learning Blog displays a scrollable list of Learning Reflections 49 entered by the user. Each Learning Reflection 49 includes a Date/time stamp 45 and is linked to an Edit Entry button 46. A Private Indicator 47 is displayed if the note is not for public distribution. The user can press the Scroll buttons 48 to scroll through the learning reflections. New learning reflections can be added by pressing the Add Entry button 50.

The Back button 51 returns the user to the exact spot in the program where they left to access the journal. The return destination is displayed above the button.

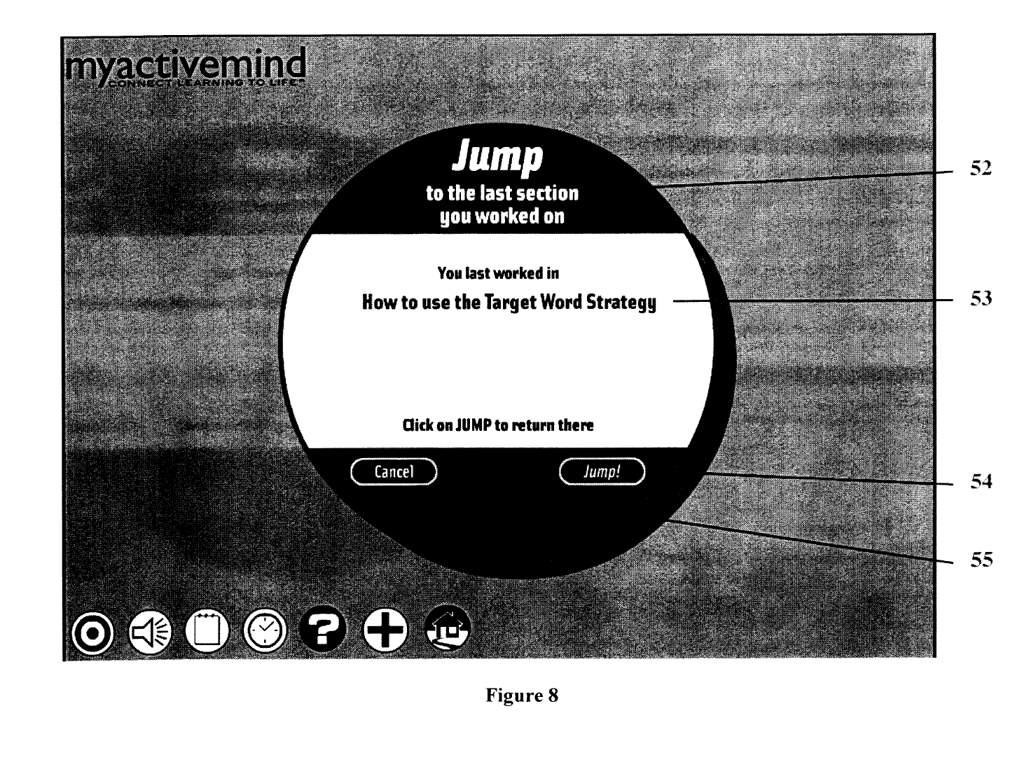

FIG. 8 displays the Jump To The Last Section Worked On feature. This page displays a Short Description 53 of the page last worked on. The user can press Jump Button 54 to go to that page or press Cancel button 55 to return to the previous page. This feature allows the user to quickly return to the exact last page worked on, providing continuity between sessions or when recovering from an equipment or connection malfunction.

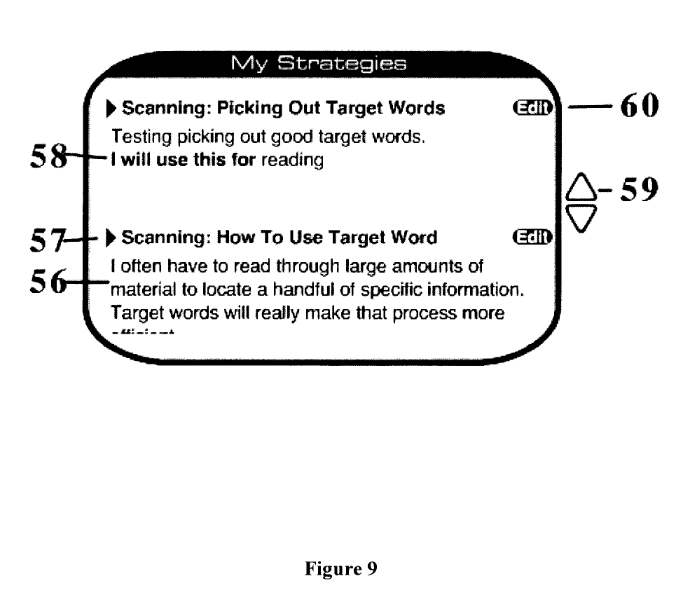

FIG. 9 is the view of My Strategies for handhelds and Internet-enabled portable devices. This screen displays a scrollable list of specific pages from the instructional program that are identified by the Page Reference 57. The Page Reference 57 is also a live link that, when pressed, will take the user to the original instructional page for review. The Personalized Note 56 the user previously entered about the instruction appears below the Page Reference 57. The Situations When The Instruction May Be Helpful 58 appear after the Personalized Note 56. Each Page Reference 57 is linked to an Edit Strategy button 59. The user can press the Scroll buttons 60 to scroll through the strategies.

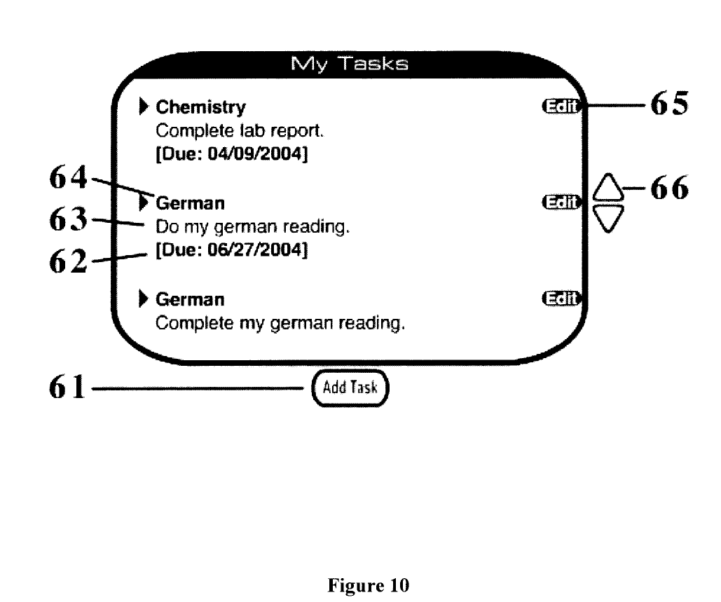

FIG. 10 is the view of My Tasks for handhelds and Internet-enabled portable devices. This screen displays a scrollable list of tasks entered by the user. Each task has a Description 63 and a Class or Activity 64 associated with the task. Each task has a Due Date 62 and is linked to an Edit Task button 65. The user can press the Scroll buttons 66 to scroll through the tasks. New tasks can be added by pressing the Add Task button 61.

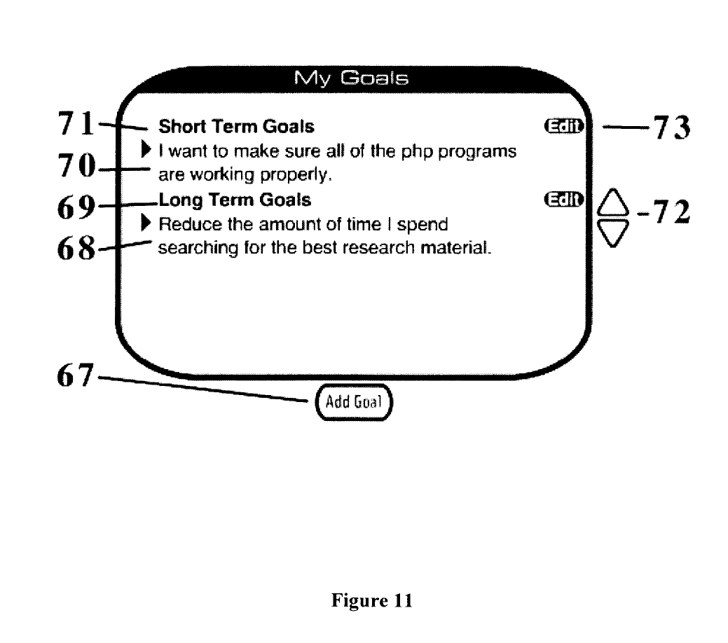

FIG. 11 is the view of My Goals for handhelds and Internet-enabled portable devices. This screen displays a scrollable list of Goals 68 that are displayed under either the Long-term Goal Header 69 or Short-term Goal Header 71. Each Goal 68 can be edited by pressing the Edit Goal button 72 associated with it. The Scroll buttons 73 are used to scroll through the list of Goals 68. Pressing the Add Goal button 67 allows the user to add a new goal.

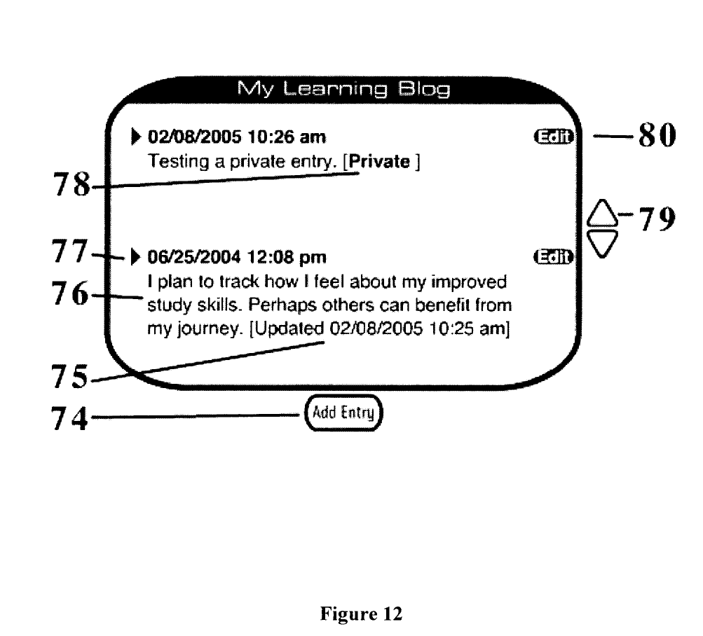

FIG. 12 is the view of My Learning Blog for handhelds and Internet-enabled portable devices. This screen displays a scrollable list of Learning Reflections 76 entered by the user. Each Learning Reflection 76 includes a Date/time stamp 77 and is linked to an Edit Entry button 79. A Private Indicator 78 is displayed if the note is not for public distribution. The user can press the Scroll buttons 80 to scroll through the learning reflections. New learning reflections can be added by pressing the Add Entry button 74.

How the program achieves its objectives:

Users access the online education program using this system and method through an Internet-connected device, such as a Web browser or a standalone application on a desktop computer, laptop computer or other portable Internet-connected devices with sufficient capabilities. The personalized instructional notes, tasks, goals and learning reflections can also be accessed through handheld devices, PDAs, Web-enabled cellphones and other portable Internet-connected devices that will be developed.

As the user proceeds through the program, information from the user's device is sent over the Internet to the server for processing and storage in the database. The information sent is either entered by the user or automatically generated by the system to aid in tracking the user's position in the program.

The first information the user enters is their login information (FIG. 1). When the server-side processing verifies that the user's username and password match a valid user, that information is passed back to the user's device and the user is moved to the home page of the program (FIG. 2). If the user is not authenticated, they are asked to login again. A successful login connects the user to the program and their personalized information stored in the database.

After logging in, the user has the option of jumping back to where they last worked. The user can press the Jump To where I Last Was button (FIG. 2, #6) to display a short description of where they last worked (FIG. 8). The user can then choose to jump back to that section or select another option in the program.

The system is able to return the user to their last page worked on because the user's movements in the program are tracked. Each page in the program has a unique identifier. When a user selects a page, the system sends that unique identifier over the Internet to be stored in the database on the server. This occurs in the background and does not slow the user down.

When the user is on a page of instruction and decides they would like to save it into their personal library of instruction, they can press the Add To My Journal button (FIG. 3, #10) that appears on every page in the program. Each page in the program has descriptive information and a unique identifier associated with it. When the Add To My Journal button is pressed, the Add To My Journal palette is displayed floating over the instructional page (FIG. 4). The palette identifies itself as “Add To My Journal” (FIG. 4, #14). The short descriptive information associated with the page (FIG. 4, #15, and #16) is displayed on the palette. The user has the option to enter their own note related to this instruction (FIG. 4, #17). The user also has the option to check boxes and add additional descriptive text to note situations where this instruction will be important (FIG. 4, #18 and #19). Once done, the user can press the Save button (FIG. 4, #20) to store the information or the Cancel button (FIG. 4, #21) if they decide against storing the information. If the save button is pressed, the system sends the information the user has entered, the information associated with the instructional page and the user's unique identifier over the Internet to the database on the server. The database is indexed on a selection of fields to optimize retrieval, search and sorting.

After either the Save or Cancel button is pressed, the Add To My Journal palette is taken off the screen and the user remains in place on the page of instruction.

One of the options the user has is to press the At A Glance button (FIG. 3, #12) to display the context of their instruction. This button appears on all pages of instruction and enables the user to see where they are within their instruction as well as providing another method of navigating to a different place in the instruction. Once the At A Glance button is pressed, the instructional context screen is displayed (FIG. 5). This screen provides a visual display of the components and sequence of the instruction. A “You are here” Star and Text are displayed next to the user's current position within the overall instruction (FIG. 5, #24). The system knows the user's current position through the unique page identifier stored in the database on the server. The system queries that identifier, then maps it against the information structure of the instruction, which is also stored in the database. The components of the instruction are represented by the Modules (FIG. 5, #23), each of which have their own unique internal identifier. The system relates the user's position to the Modules to assign the position of the “You are here” Star and Text. Pressing one of those Modules will take the user to that point in the program represented by the Module. The user can press the Back button (FIG. 5, #25) to return to the exact place where they first pressed the At A Glance global button (FIG. 3, #12).

From any point in the program, the user can access the personalized components of My Journal through the global Review My Journal button (FIG. 3, #9). When the user presses this button, the system sends the user's unique identifier over the Internet to the server to retrieve and sort the data that comprises each of the My Journal components.

The My Journal components are displayed on separate parts of the screen (FIG. 7) under a Personalized Page Header (FIG. 7, #38) as follows:

My Goals displays a scrollable list of Goals (FIG. 7, #3) that are displayed under the Goal categories (FIG. 7, #31) (short or long-term goals). Each goal can be edited by pressing the Edit Goal button (FIG. 7, #32) associated with it. The editing process may include deleting the goal. Pressing the Add Goal button (FIG. 7, #28) allows the user to add a new goal. After a goal is added, edited or deleted, the information is sent over the Internet to the server for processing and updating the database. Then the user's information is retrieved from the database to update the My Journal screen. The user's modification's will now be part of the My Goals display. The Scroll buttons (FIG. 7, #29) are used to scroll through the list of goals.

My Strategies displays a scrollable list of specific pages from the instructional program that are identified by the Page Reference (FIG. 7, #34). The Page Reference is also an active link that, when pressed, will take the user to the original instructional page for review. This is possible because each page in the program has a unique identifier. That identifier is stored in the database with the My Strategy entry and serves as a link to the location of the page, which is also stored in the database. That location is retrieved as part of the data returned when the user opens My Journal. The data allows the entries to be sorted in a variety of ways such as grouping notes on related instruction together or by date entered. The Personalized Note (FIG. 7, #33) the user previously entered about the instruction appears below the page reference. The Situations When The Instruction May Be Helpful (FIG. 7, #38) appear after the Personalized Note.

Each Page Reference can be edited by pressing the Edit Strategy button (FIG. 7, #37) associated with it. The editing process may include deleting the strategy. After a strategy is edited or deleted, the information is sent over the Internet to the server for processing and updating the database. Then the user's information is retrieved from the database to update the My Journal screen. The user's modification's will now be part of the My Strategies display. The user can press the Scroll buttons 8 to scroll through the strategies.

My Tasks displays a scrollable list of tasks entered by the user. Each task has a Description (FIG. 7, #41) and a Class or Activity (FIG. 7, #39) associated with the task. Each task has a Due Date (FIG. 7, #43) that is assigned by the user. The tasks can be sorted in a variety ways such as by Due Date or by the Class or Activity the task is linked to.

Each task can be edited by pressing the Edit Task button (FIG. 7, #40) associated with it. The editing process may include deleting the task. Pressing the Add Task button (FIG. 7, #44) allows the user to add a new task. After a task is added, edited or deleted, the information is sent over the Internet to the server for processing and updating the database. Then the user's information is retrieved from the database to update the My Journal screen. The user's modification's will now be part of the My Tasks display. The user can press the Scroll buttons (FIG. 7, #42) to scroll through the tasks.

My Learning Blog displays a scrollable list of Learning Reflections (FIG. 7, #49) entered by the user. Each learning reflection includes a Date/time stamp (FIG. 7, #45). A Private Indicator (FIG. 7, #47) is displayed if the note is not for public distribution. The user indicates whether a learning reflection is private or not during the add or edit entry process. The learning reflections can be sorted in a variety of ways such as by date entered, dated edited or private/public.

Each learning reflection can be edited by pressing the Edit Entry button (FIG. 7, #46) associated with it. The editing process may include deleting the learning reflection. Pressing the Add Entry button (FIG. 7, #50) allows the user to add a new learning reflection. After a learning reflection is added, edited or deleted, the information is sent over the Internet to the server for processing and updating the database. Then the user's information is retrieved from the database to update the My Journal screen. The user's modification's will now be part of the My Learning Blog display. The user can press the Scroll buttons (FIG. 7, #48) to scroll through the learning reflections.

The Back button (FIG. 7, #51) returns the user to the exact spot in program where they left to access the Journal. The return destination is displayed above the button. The system is able to do this because it noted the unique identifier, location and short description of the user's last page when the user pressed the Review My Journal button to access My Journal.

The handheld version of each of the My Journal components function in a near identical manner to the full versions described above. The possible difference may involve the amount of instructional material the My Journal components can link to. That will be a limitation of the handheld device. Online education programs that make use of this system and method will have to accommodate limitations of the handheld device such as the device's screen display capabilities and processing power. These limitations would affect the use of the link from a My Strategies' entry (FIG. 7, #34) and the Back button (FIG. 7, #51). Otherwise, the functionality on the handheld device matches that of the full version.

### ALTERNATIVE EMBODIMENTS OF THE PROGRAM

The example names My Journal, My Strategies, My Learning Blog, My Goals and My Tasks can be considered placeholders for descriptive purposes. They can be altered as desired to better suit other implementations. For example, the program can be adapted for a wide range of uses beyond what the broad terms education and training normally refer to. Some examples include: employee manuals and guides; human resource guides; technical manuals and guides; self-support techniques; customer, prospect, client and/or sales management; research; opinion research, focus groups and/or polling; certifications; and medical trials.

The program can also be used to exercise the mind in a manner useful to senior citizens and others who are concerned with the loss of memory and mental abilities.

The program can be used on other forms of connectivity and communication that currently do not exist or will be developed.

Not all of the components described herein are necessary for the program to be effective.

Online education on other forms of devices that may be developed in the future which supplant, extend or mimic the function of computers, handheld devices, etc. can use this system and method.

While the claimed invention has been described in detail and with reference to specific embodiments thereof, it will be apparent to one of ordinary skill in the art that various changes and modifications can be made to the claimed invention without departing from the spirit and scope thereof.

### Example Alternative Embodiment

### Medical Trials

### Example Implementer: Independent Labs

### Example User: Subject Who is Part of the Medical Trial

Subjects can personalize the information provided by the lab, can log their reactions, unusual occurrences, more information about their experience using the one-click personalization.

The information subjects choose to store will be in context and enhance by linking to the their own profile.

Subjects are able to log the timing of their dosages and experiences with those dosages.

Labs have real-time data on their subjects' experience during the trial.

Labs will have access to profile data enhanced by the subjects' own personalization of their experience.

Log their reactions based on same one-click personalization. Learning about a specific reaction, occurrence, curiosity about their experience,

Will also log when they take, what they take, dosages, etc.

### Example Alternative Embodiment

### Certifications

### Example Implementer: Certification Training Program

### Example User: Student in the Training Program

This is an instructional context, so all of the claims made for the main embodiment apply.

In addition, training programs can offer their students access to their personalized library of training materials beyond the conclusion of their training.

Often, companies will pay for the employees to take certification programs. Implementing our personalization program allows for those companies to get real-time data of how their employees are doing, as well as a more complete profile on them.

Continued access to the personalized libraries enhances the value of the training, both for the employee who took it as well as the company that paid for the training.

### Example Alternative Embodiment

### Focus Groups and/or Polling

### Example Implementer: Focus Group Company, Political Campaign, Opinion Research Company

### Example User: Ordinary Citizen

Users work through questions, surveys, interest areas while being encouraged to note the items or information that is most interesting to them. Our simple system makes this easy and encourages users to utilize the personalization features.

Customers gain access to unique, detailed profile of users which the users themselves make. This enhances the data they are collecting.

### Example Alternative Embodiment

### Research

### Example Implementer: Companies Who Sell Research

### Example User: Clients of those Research Companies

Using our personalization program, users can create a personalized research library.

That library will be enhanced by mapping it to the user's profile, other research gathered, and suggestions of related research.

Users can set preferences for the topics, sources and/or kind of research they are in. This makes research sessions more effective and more powerful.

Customers can access to unique, detailed profile of users. This enables them to suggest other products the users may be interested in as well as enhance their products.

The personalized library feature will enhance user loyalty because they have invested time and energy into the creation of the library.

### Example Alternative Embodiment

### Customer, Prospect, Client and/or Sales Management

### Example Implementer: any Company Selling a Product or Service Through a Web Site

### Example User: a Customer or Potential Customer of that Company

A concrete example: Monica is a customer of an online spice store. The spice store knows their customers tend to buy the same products over and over. If Monica could customize her experience on their site by storing the products she uses repeatedly, the spice store could map those products to related products as well as recipes using those and other products. The spice store gains by increasing Monica's loyalty to them, by streamlining the purchasing process, by gathering additional information about their customers and allowing them to efficiently target market customers.

Users can add information about company products or services into their personalized library for later retrieval.

Users will find this especially useful for quickly and efficiently purchasing items or services they purchase on a regular or semi-regular basis.

The program can enhance the information the user stores by mapping it to the users profile, other items the user is interested in or previously purchased, related items. The program can also enhance the stored information by comparing it to others who have found interest in the same or related products or services.

Companies that implement our personalization program will gather a great deal of information about their customers, enhancing their ability to market their products or services.

Companies that implement our personalization program will find an increase in customer loyalty directly related to the ownership customers feel toward their personalized library of products, services and related material.

### Example Alternative Embodiment

### Self-Support Techniques

### Example Implementer: Any Company Selling or Offering Self-Help Products, Services or Information through a Web Site

### Example User: Any One in Search of Self-Help Information, for Example, Health, Diet, Fitness, Smoking, Job Search, Screen Writing, Car Repair, Mental Health, etc.

Personalizing the self-help experience is especially important. People want information that specifically addresses their needs. Companies that implement our personalization program enable their users to create their own library of self-help information.

The program can enhance the information the user stores by mapping it to the user's profile, and other areas the user is interested in. The program can also enhance the stored information by comparing it to others who have found interest in the same information.

The more the user adds to their personalized library, the more program is able to recommend related information.

The more a user feels they are finding information that is specifically useful to them, the more likely that user will continue to use that web site.

Companies that implement our personalization program will be able to efficiently target market their users based on the information stored in their personalized library.

### Example Alternative Embodiment

### Technical Manuals and Guides

### Example Implementer: Any Company Selling Products which Have an Accompanying Manual

### Example User—Someone who Purchased a Product with a Manual

Companies that sell products with accompanying manuals want their customers to use those manuals to learn about using the product and solving problems with the product. Frequently, those manuals cover aspects of the product that the user may not be interested in or find relevant to them. By implementing our personalized program with an online version of the manual, users will be able to create their own personalized version of the manual.

In some cases, manuals contain information that needs to be referred to on a regular or semi-regular basis. Our personalization program enables users to store that information in their own library and return to it quickly when they need it.

The company benefits by reducing their support costs because the customer is essentially supporting themselves. Implementing our personalization program with an online version of their manual enhances the user's ability to support themselves.

Companies that implement our personalization program will be able to efficiently target market their users based on the information stored in their personalized library. The information may also be useful in improving products as it provides insight into how a user approaches, uses and solves problems with a product.

### Example Alternative Embodiment

### Employee Manuals and Guides; Human Resource Guides

### Example Implementer: Any Company with an Employee Manual, Any Company with a Human Resources Department

### Example User: an Employee of that Company

Employee manuals and human resource guides can be considered instructional materials for a companies employees. It is important that each employee learn rules of conduct, guidelines, and all other information that a company deems is important. By implementing our personalized program with an online version of the employee manual, employees can create their own library of information which is most relevant to their own situation.

The company benefits by reducing their human resource costs because the employee's ability to find information applicable to them is enhanced.

When an employee adds information to their library, the system can suggest related material which the employee may also find useful. The increases the effectiveness of the system and may further reduce human resource costs.

Companies can improve their employee manuals by analyzing the information their employees add to their personalized libraries.

We claim:

1. An online education system comprising:
a computer system providing instructional materials and a personalized education program in communication with the internet;
the personalized education program allowing access to instructional materials throughout a user's attendance at a school, college or training institution;
the personalized program allowing entry of personalized notes regarding specific instructional material while remaining in place within the program, wherein the notes become part of the user's personalized library of instruction and can be viewed, modified and deleted by the user;
the personalized program automatically indexes the personalized notes with respect to the specific instructional material and builds a personalized library; and
the personalized program providing one-click access to the specific instructional material from the personalized notes.

2. A system according to claim 1, further comprising providing access to the personalized instructional notes through handheld, web-enabled cellphones and other portable devices.

3. A system according to claim 1, further comprising providing a persistent button available at all points in the instructional material.

4. A system according to claim 1, further comprising providing a one click function so that when a user encounters instructional material or other information that they would like to include in a personalized library, the user is able to add that information into their personal library with one mouse click of a button, which is always available in the instructional program, to store a reference to that specific instructional material or other information into their personal library.

5. A system according to claim 1, further comprising providing a separate window allowing the user to enter notes and references to other material.

6. A system according to claim 5, wherein when the window is opened, the program maintains the user's position in the main instructional material allowing the user to return immediately to that material once the window is closed.

7. A system according to claim 1, wherein the program provides for returning to the material at any time.

8. A system according to claim 1, wherein the system provides suggestions on the application of the instructional material.

9. A system according to claim 8, wherein the system suggests related material which the user may opt to include into their library, and the user may include the related material at the point of creating an entry or at a later point when they are reviewing that entry.

10. A system according to claim 8, wherein the system decides application suggestions in part based on the student's profile and other material the user has previously stored.

11. A system according to claim 9, wherein the system provides a short summary and a link to more material.

12. A system according to claim 1, wherein the program provides users with an option to share material with others.

13. A system according to claim 12, wherein the communication with students is with a blog.

14. A system according to claim 1, wherein the program enables users to opt not to store information in their personalized library.

15. A system according to claim 1, wherein the program enables each user to search, organize and retrieve material stored in their personalized library of instructional information through multiple methods.

16. A system according to claim 15, wherein the material can be searched or organized by key words, tags, categories, application of stored instruction, date entered, visual navigation through text or graphical representations of the hierarchy of the instructional material.

17. A system according to claim 1, wherein the system enables each user to create a personalized library of instructional material which can be searched, viewed, read and manipulated through a Web-enabled cellphone or other handheld device capable of viewing Web sites.

18. A system according to claim 1, wherein the system enables each user to create a personalized library of instructional material where each entry can be printed, edited, deleted and modified.

19. A system according to claim 18, wherein when a user reviews the information stored in their personal library they have the option to share the information with others through an electronic communication.

20. A system according to claim 1, wherein the system tracks the users movements through the system, storing the precise location the user is at each time the user switches to a new page, location or piece of information in the system.

21. A system according to claim 20, wherein users can jump back to the precise point they last were in instructional material when they start a new session or after they have had a communication break due to hardware, software or other communication issue.

22. A system according to claim 20, wherein the program stores the history of what instructional material and other material presented, stored or linked by the system which has been accessed by the user as part of the user's profile.
